(19) United States
(12) Patent Application Publication
(10) Pub. No.: US 2014/0165414 A1
(43) Pub. Date: Jun. 19, 2014

(54) Tape Measure Hook Grip

(71) Applicant: Braden L. Smith, Lafayette, CO (US)

(72) Inventor: Braden L. Smith, Lafayette, CO (US)

(73) Assignee: Braden L. Smith, Lafayette, CO (US)

(21) Appl. No.: 13/717,683

(22) Filed: Dec. 17, 2012

(51) Int. Cl. G01B 3/10

(52) U.S. Cl. CPC G01B 3/1056
USPC 33/768

(57) ABSTRACT

A tape measure tape hook with a grip that allows extending the tape without engaging the tape hook directly. The grip may be positioned to extend beyond the tape hook in one position, and retracted by rotating, sliding, or bending such that it may be positioned behind the tape hook in a second position, so as to avoid interfering with measuring.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention relates to flexible measuring devices, such as tape measures, that have as an integral part a recoiling graduated rule and a hook on the end of the rule.

Common tape measures today have a spring recoil system that retracts the tape into the case after use. These tapes have a concave cross section that allows the blade to become rigid when extended. This cross section collapses flat as it is recoiled.

This rigidity allows a worker to measure from a surface by abutting the end of the tape against that surface by pushing it up to it. Imagine measuring from a wall along the floor. Conversely, he can hook the end of the tape on an edge and pull it. Imagine measuring from the edge of a table. Thus, there are two main ways to initiate a measurement with these types of tape measures. This invention will take both situations into consideration.

This hook also prevents the tape from retracting all the way into the case. Generally, a user will grab the tape hook to extend the tape. This works, though the hook is not designed to be manipulated by hand, rather, it is designed for adhering to the material to be measured, sometimes with sharp points. These points may pose a safety threat to the user's fingers.

There are other uses by tradesmen that are not apparent to the layman. Often, a worker will hold a pencil against the underneath side of the case while holding the hook on an edge of material such as drywall. He will then simultaneously slide the hook along the edge, and the case (and pencil tip) along the material. This will result in striking a line parallel to the edge on the material. Because the tape hook has little for the user to hold onto, the process can be difficult, especially if a minor obstruction on the edge catches the hook.

Other tape measures have been developed that allow a marker to be affixed to the case. U.S. Pat. No. 2,807,886 (A.B. Aciego) for example, has a clip that holds a pencil onto a tape case. U.S. Pat. No. 4,760,648 (Doak et al.) has an attachment that holds a marker. U.S. Pat. No. 6,612,046 (Cimorell et al.), and U.S. Pat. No. 6,698,104 (Scarborough) incorporate a marking device into the tape case. These create a marking device similar to a compass. By holding the tape hook against the material as a pivot, the user may strike an arc with the marker. This again may be difficult to do without some aid in holding the tape hook.

Often with these designs, the marker is held in front of the case with the tip next to the tape. This allows the user to align the markings on the tape with the tip of the marker. Though convenient for that purpose, it still disposes the tip of the marker in front of the tape hook when the tape is retracted. The user will often find an interference with the marker tip when pulling the tape out by the hook in the customary manner. A juicy marker will leave its signature on the user's finger and a sharp pencil or knife will do worse. Some means of allowing the worker to extract the tape without risking this would be a welcome design.

Of the prior art, much of what would work in one case would not in another. For instance, some tape hooks have a tab on the top that is used to hook underneath objects. U.S. Pat. No. 6,637126 B2 (Balota), U.S. Pat. No. 6,860,031 B2 (Odachowski), U.S. Pat. No. 7,131,215 B2 (Kang), U.S. Pat. No. 7,055,261, B2 (Nam), and U.S. Pat. No. 7,805,855 (Seo) all have vertical portions above the tape on the hook. This would work as somewhat of a handle for sliding and pivoting, but still presents a problem when extracting the tape as the tab is against the tape case when retracted.

U.S. Pat. No. 6.691,425 (Lee), U.S. Pat. No. 5,542,184 (Beard) have tape hooks or ends that are specifically designed to be somewhat of a handle for holding and using a pencil or knife with. Because the speed at which tape measures recoil, any substantial weight on the end will become a dangerous projectile as it zips back into the case. For this reason, tape measures with end handles such as these pose a safety problem. Therefore, any adaptation to enhance the tape hook will require a minimum of additional weight. And if a collision between the modified tape hook and the user's hand is to occur, it would be best to have a soft material meet the skin.

Long tape measure “stand out” is a sought after benefit and has been the focus of several tape measures lately. This is the condition where the rigidity due to the concave cross section allows the tape to remain stiff as the tape is extended. A worker may need to extend the tape a distance through space before it can effectively rest on an edge. Any additional weight on the end of the tape will reduce the stand out and become a hindrance to this objective.

Therefore, considering the aforementioned uses of a tape measure with marking devices in sliding and pivoting the tape hook, extracting the tape hook in these differing configurations, the varying measuring situations, and the safety issues regarding material and additional weight, there exists an opportunity to provide an elegant solution that will meet these criteria. This new invention will provide an economical, safe, convenient, and effective solution for reasons that will become obvious.

### BRIEF SUMMARY OF THE INVENTION

This invention generally comprises a slight modification to the tape hook that will allow a minimal handle or grip to be attached to it. Because of the measuring conditions; sometimes the tape is pushed up to a surface, sometimes it is hooked and pulled, the grip will need to avoid getting between the tape hook and surface or edge. This would throw off the measurement. Therefore, there should be some means of allowing the grip to be moved out of the way.

In the preferred embodiment of the invention, a length of flexible cord is tied around a portion of the tape hook. This cord extends forward past the end of the tape hook, away from the tape case. This allows the user to easily extract the tape from the case without worrying about attached implements such as drawing or cutting utensils or catching sharp tips on the hook. A knot is tied toward the end of the cord to allow a positive grip. It can also be a double strand, such that the knot creates a loop. A finger can use the loop for convenience or it can be fitted over a fixed nail.

Because the cord is tied around a portion of the tape hook, a natural hinge or pivot is created where the cord can be moved to a second position, ideally rotated back upon the tape, avoiding interference with the surface or edge being measured against. Secondarily, the cord may be clamped or affixed in any number of ways such that by bending the cord it will not interfere with measuring.

The cord is light weight enough to not add considerable weight, and has a minimal effect upon colliding with the hand. Further, a short piece of cord is inexpensive and requires no custom tooling to manufacture.

In other embodiments, the flexible cord may be substituted with (but not limited to) any natural or synthetic fibrous material, cloth, paper, leather, elastomeric (rubber) cord, plastic, plastic or metal chain, wire, or any combination of these. Additionally, ridged grips may be used (but not limited to) any natural or synthetic material, plastic, metal, wood, rubber, or any combination of these.

### OBJECTS AND ADVANTAGES

A primary advantage of the invention is to provide an effective handle for holding the end of a tape measure tape. More importantly, it is to be able to effectively handle the tape hook when using a marking or cutting device with a tape measure. This is done while sliding the tape hook along an edge while creating parallel slide marks, or holding the hook as a pivot for creating arcs and circles.

Another object is to provide a lightweight material for this grip, insuring minimal safety risk and optimal stand out.

Another objective is to provide a first position such that the grip extends along the tape out past the tape hook such that the user may avoid contact with additional attached marking and cutting implements when extending the tape.

Another advantage is to provide a secondary position of the grip so that it may be rotated or bent out of the way and will not interfere with measuring.

Another advantage is the convenient and safe ability to extend the tape without touching a sharp tape hook.

### BRIEF DESCRIPTION OF THE DRAWINGS

FIG. 1 illustrates a tape measure (1) with a utensil clamp (2) holding a pencil (4) with the pencil tip (6) beside an extended graduated tape (8). A grip cord (10) is attached to a tape hook (12) and extends forward of the tape hook.

Now referring to FIG. 2, the tape hook (12) has a first portion (14), generally parallel to the tape (8), and mounted to the tape by means of a plurality of rivets (16) and a second front portion (18) of the tape hook generally perpendicular to the first portion. The grip cord (10) is tied to a portion of the tape hook (20). A knot (22) secures the ends of the grip cord, providing a positive grip and loop (24).

FIG. 2A is a side view FIG. 2.

FIG. 3 illustrates the grip cord (10) having been rotated back in a secondary position away from the front of the tape hook (18).

FIG. 3A is a side view FIG. 3.

FIG. 4 shows a variation of the invention where the grip cord (10) is able to slide back away from the front of the tape hook (18).

FIG. 4A is a side view of FIG. 4.

FIG. 5 shows the grip cord (10) in a secondary position having been slid back along the tape (8) away from the front of the tape hook (18).

FIG. 5A is a side view of FIG. 5.

FIG. 6 illustrates the grip cord (10) firmly fastened to the tape hook (12) by a crimp (28) in the tape hook, extended past the end of the tape hook.

FIG. 6A is a side view of FIG. 6.

FIG. 7 illustrates the grip cord (10) being bent back in a secondary position away from the front of the tape hook (18).

FIG. 7A is a side view of FIG. 7.

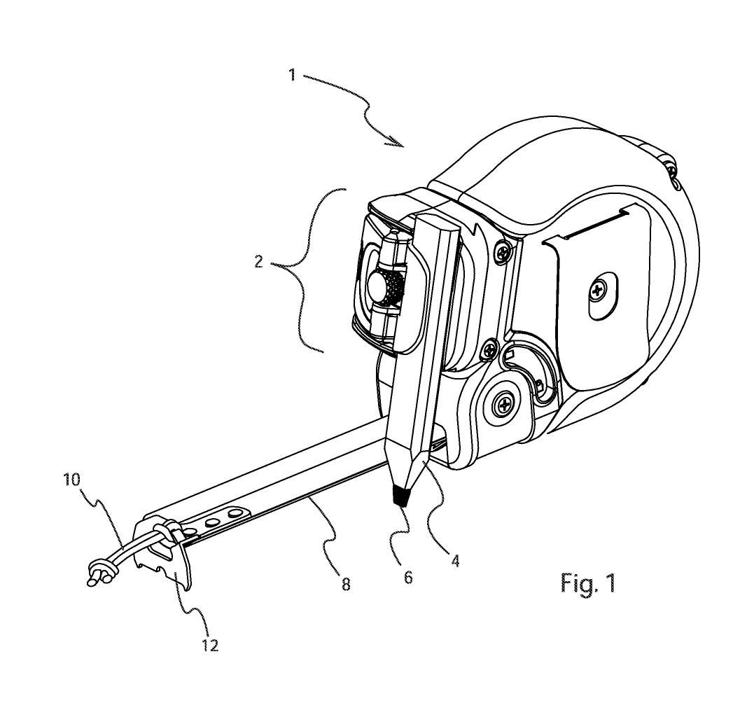

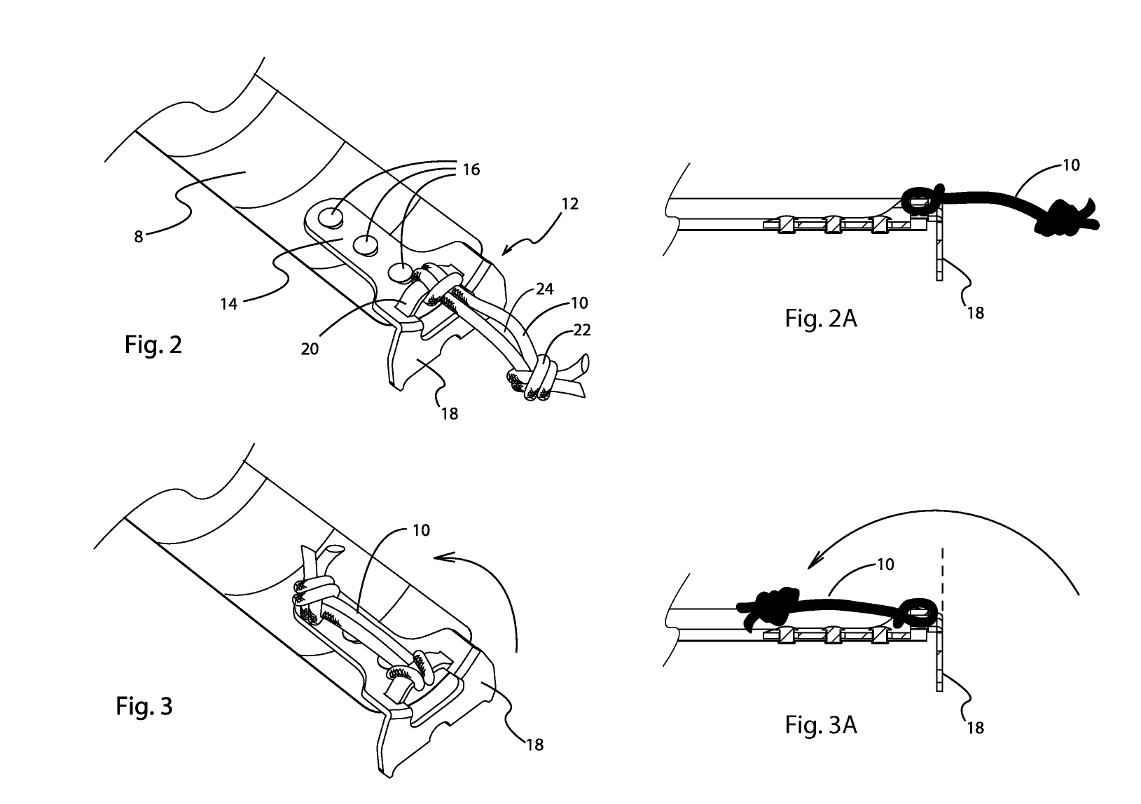

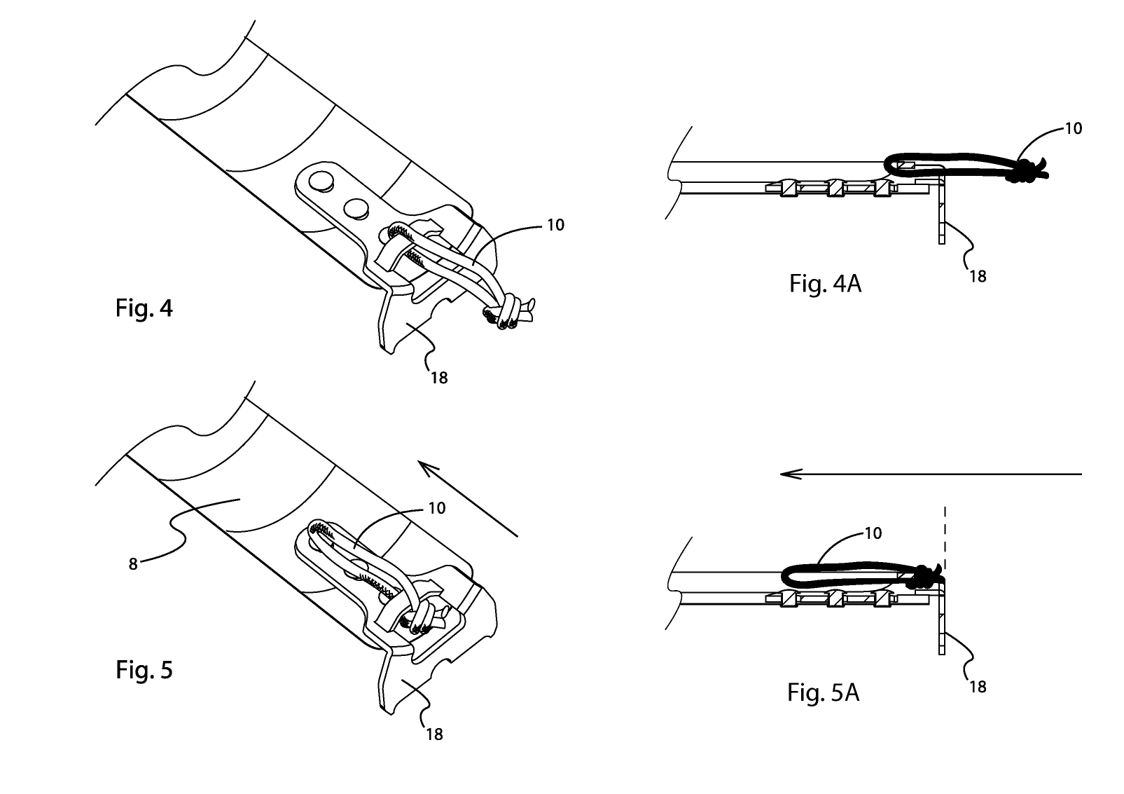

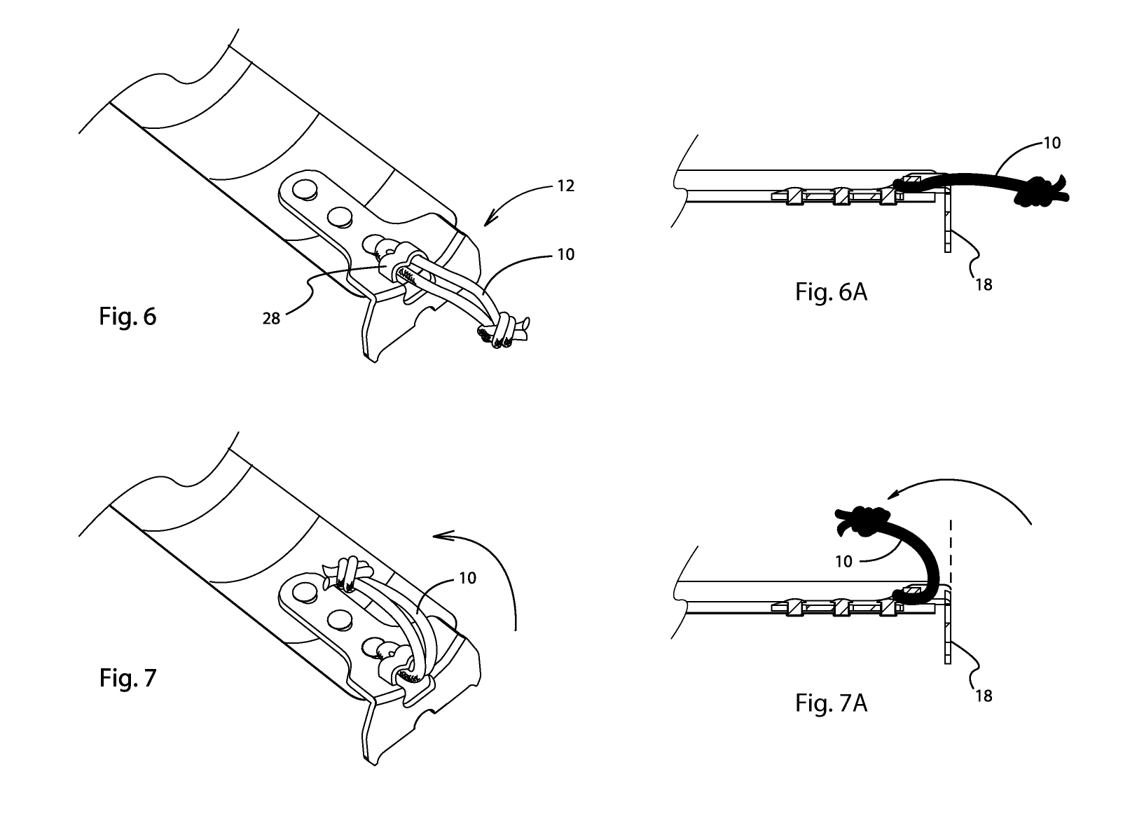

The above descriptions are the preferred embodiment and are provided as one means of configuring the present invention, but there are also other embodiments that may be employed that do not depart from the nature of the invention. The drawings, descriptions and objectives are not to be taken as limiting the invention as many other configurations and advantages will become apparent to a craftsperson using this invention. Future embodiments of this invention are confidently expected to be developed, manufactured, and employed in useful work.

Other configurations of the present invention may be executed. Component and device forms, materials, and sizes may be changed without departing from the nature of the invention. Component and device positions, relations, configurations, means of activating, not specifically limited by the claims, are also available to be explored in other embodiments.

Examples of this would be placing the grip on another part of the tape hook; underneath, on the side, or with a different tape hook configuration entirely, designed for uses yet to be created. Embodiments may incorporate a plurality of grips, combinations of the mentioned uses, or materials and processes.

I claim:

1. A tape measure having an extendable recoiling graduated flexible tape, said tape having a concave cross section when extended, a housing substantially surrounding said tape when recoiled, a tape hook mounted to the extendible end of the tape, said hook having a portion riding along the tape with a secondary portion primarily perpendicular to said first portion, and a handle or grip affixed to said hook wherein:
(a) said grip extends beyond the front of the tape hook, away from said housing, in a first position;
(b) said grip may be retracted behind the end of the tape hook in a second position.
(c) said grip may be returned to said first position
(d) said grip is flexible.

2. The article in claim 1 wherein the grip has a rotating means for moving from said first position to said second position.

3. The article in claim 1 wherein the grip slides along the tape from the first position to the second position.

4. The article in claim 1 wherein the grip flexes from the first position to the second position.

5. The article in claim 1 wherein the grip has an enlarged portion to aid in grasping.

6. The article in claim 1 wherein the grip has a loop or hole.

7. A tape measure having an extendable recoiling graduated flexible tape, said tape having a concave cross section when extended, a housing substantially surrounding said tape when recoiled, a tape hook mounted to the extendible end of the tape, said hook having a portion riding along the tape with a secondary portion primarily perpendicular to said first portion, and a handle or grip affixed to said hook wherein:
(a) said grip extends beyond the front of the tape hook, away from said housing, in a first position;
(b) said grip may be retracted behind the end of the tape hook in a second position.
(c) said grip may be returned to said first position
(d) said grip is rigid.

8. The article in claim 7 wherein the grip has a rotating means for moving from said first position to said second position and back.

9. The article in claim 7 wherein the grip has a sliding means for moving from said first position to said second position.

10. The article in claim 7 wherein the grip has an enlarged portion to aid in grasping.

11. The article in claim 7 wherein the grip is covered in a generally cushioning material.

12. The article in claim 7 wherein the grip has an opening such as a loop or hole.

13. The article in claim 7 wherein the grip has a texture to aid in gripping.

14. A tape measure having an extendable recoiling graduated flexible tape, said tape having a concave cross section when extended, a housing substantially surrounding said tape when recoiled, a tape hook mounted to the extendible end of the tape, said hook having a portion riding along the tape with a secondary portion primarily perpendicular to said first portion, and a handle or grip affixed to said hook wherein:
(a) said grip extends beyond the front of the tape hook, away from said housing, in a first position;
(b) said grip may be retracted behind the end of the tape hook in a second position.
(c) said grip may be returned to said first position
(d) said grip has a flexible portion and a rigid portion.

15. The article in claim 14 wherein the grip has a rotating means for moving from said first position to said second position.

16. The article in claim 14 wherein the grip slides along the tape from the first position to the second position.

17. The article in claim 14 wherein the grip flexes from the first position to the second position.

18. The article in claim 14 wherein the grip has an enlarged portion to aid in grasping.

19. The article in claim 14 wherein the grip has an opening such as a loop or hole.

20. The article in claim 14 wherein the rigid portion of the grip has a texture to aid in gripping.
